(19) United States
(12) Patent Application Publication
(10) Pub. No.: US 2010/0006590 A1
(43) Pub. Date: Jan. 14, 2010

(54) Liquid Dispensing Applicator with Flexible Valve Member

(76) Inventors: Robert Withoos, Victoria (AU); Colin Newson, Victoria (AU)

Correspondence Address: KING & SPALDING, 1180 PEACHTREE STREET , NE, ATLANTA, GA, 30309-3521, US

(21) Appl. No.: 12/158,907

(22) PCT Filed: Dec. 22, 2006
(86) PCT No.: PCT/AU06/01967

§ 371 Date: Aug. 13, 2009

(30) Foreign Application Priority Data
Dec. 23, 2005 (AU) 2005907296
Jun. 1, 2006 (AU) 2006902974

(51) Int. Cl. B67D 3/00; B65D 47/00

(52) U.S. Cl. 222/1; 222/562

(57) ABSTRACT

The invention concerns a liquid dispensing applicator for a volatile liquid. The liquid dispensing applicator includes a cap member for attachment to a hollow bodied container having a reservoir for retaining a liquid. The cap member comprises a sleeve to receive and conduit liquid contained within the reservoir. The applicator further includes a valve member and a dispensing member co-operating with at least the first end of the shaft. The valve member is retained within the sleeve of the cap comprising a substantially flexible shaft having a first end projecting from said sleeve exterior. The valve member is flexibly operable against a bias at said first end to move from a first substantially closed position to a second open position to allow displacement of a quantity of liquid from within the sleeve, onto the dispensing member, for subsequent application.

### CROSS-REFERENCE TO RELATED APPLICATIONS

The present application claims priority from Australian Provisional Patent Application No 2005907296 filed on 23 Dec. 2005, and Australian Provisional Patent Application No 2006902974 filed on 1 Jun. 2006, the contents each of which are incorporated herein by reference.

### TECHNICAL FIELD

This invention relates to a liquid dispensing applicator, and in particular, a liquid dispensing applicator for dispensation of polyvinyl chloride (PVC) priming fluids.

### BACKGROUND ART

Industrial liquids, in particular volatile liquids, are used in a variety of industries. For example clear PVC priming fluid is commonly used on surfaces of outdoor furniture and swimming pools. Plumbers also use the fluid to clean and prepare PVC piping. The fluid removes contaminants from the surface of the piping so that a solvent cement can be applied and sections of PVC piping joined.

Depending on the constituents, industrial liquids are typically sold in containers. Industrial liquids such as priming fluid can be discomforting to a person's eyes if exposure is prolonged. Moreover, if the fluid comes into contact with a person's skin, irritation of the skin can result. This is particularly the case when the fluid is poured from the container in which it is stored onto a cloth in order to prime surfaces of the pipe.

### DISCLOSURE OF INVENTION

The invention is a liquid dispensing applicator for a volatile liquid, the liquid dispensing applicator comprising:

a cap member for attachment to a hollow bodied container having a reservoir for retaining a liquid, the cap member comprising a sleeve to receive and conduit liquid contained within the reservoir;

a valve member retained within the sleeve of the cap comprising a substantially flexible shaft having a first end projecting from said sleeve exterior; and

a dispensing member co-operating with at least the first end of the shaft;

wherein the valve member is flexibly operable against a bias to move from a first substantially closed position to a second open position to allow displacement of a quantity of liquid from within the sleeve, onto the dispensing member, for subsequent application.

Preferably the dispensing member is absorbent. The dispensing member may comprise a porous, or sponge like, material. The dispensing member may comprise a woven fibre such as felt which may be moulded under pressure to form any desired shape. The dispensing member may be formed by compression-molding a loose fiber piece such as a fiber web. Optionally, or in addition, the dispensing member may comprise a composite, or layered material. The dispensing member may substantially surround the portion of the shaft projecting from said sleeve exterior. The dispensing member additionally surrounds at least a portion of the sleeve.

The dispensing member may be adhered in any fashion to the portion of the shaft projecting from said sleeve exterior or the portion of the shaft projecting from said sleeve exterior and sleeve. For instance the dispensing member may be adhered to the portion of the shaft projecting from said sleeve exterior or the portion of the shaft projecting from said sleeve exterior and sleeve by way of staples, glue, nails or tacks. Optionally exterior surfaces of the portion of the shaft projecting from said sleeve exterior and sleeve may be barbed and the dispensing member may be fixedly attached to the barbs.

The cap member may be removably attachable to a container. The cap member may include an internal thread to attach to a neck of a hollow bodied container. Optionally, the cap member may snap fit to a neck of a hollow bodied container.

The valve member is preferably manufactured from rubber or a flexible polyurethane material.

The valve member may further comprises a retaining member to retain a second end of the substantially flexible in position relative to the sleeve.

The shaft may be hollow to receive and conduit liquid contained within the sleeve and a slit may be provided in a portion of a wall of the first end of the shaft such that when the valve member is flexibly operated against the bias to move from a first substantially closed position to a second open position a quantity of liquid is displaced from within the first end of the shaft and from the slit, onto the dispensing member.

Optionally, the valve member may include a spring wound around the shaft.

In any of the above embodiments, a lock mechanism may be provided to prevent unintentional displacement of the valve member to the second open position. The lock mechanism may include, but not be limited to, a valve positioned within the shaft and may include means external to the shaft to open and close the valve. Optionally a substantially rigid cap may be provided to slide over and substantially surround the dispensing member. The cap may have an additional advantage of substantially preventing the dispensing member from drying out after use.

In any of the above embodiments, the liquid dispensing applicator may further comprise a container having a reservoir for retaining a volatile liquid, where the cap member is attached to the neck of the container.

### BRIEF DESCRIPTION OF DRAWINGS

Embodiments of the invention are now described by way of example with reference to the accompanying drawings in which:

FIG. 1 shows a perspective view of a first embodiment of a liquid dispensing applicator in a first substantially closed position;

FIG. 2 shows a sectional view of a portion of liquid dispensing applicator shown in FIG. 1;

FIG. 3 shows a perspective view of the liquid dispensing applicator shown in FIG. 2 in a second open position;

FIG. 4 shows a schematic illustration of a second embodiment of a liquid dispensing applicator;

FIG. 5 shows a schematic illustration of a third embodiment of a liquid dispensing applicator;

FIG. 6 shows a schematic illustration of a fourth embodiment of a liquid dispensing applicator; and

FIG. 7 shows a schematic illustration of a fifth embodiment of a liquid dispensing applicator.

### BEST MODE FOR CARRYING OUT THE INVENTION

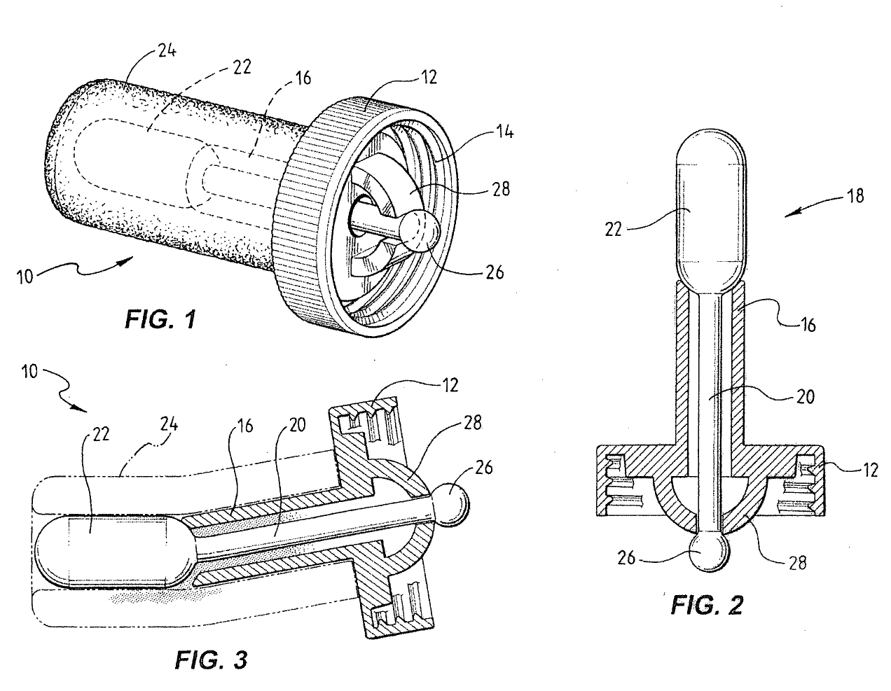

Referring initially to FIG. 1 of the drawings, reference numeral 10 generally designates a liquid dispensing applicator, in accordance with a first embodiment of the invention. The liquid dispensing applicator 10 includes a cap member 12. The cap member 12 includes an internal thread 14 to enable it to attach to a neck of a hollow bodied container having a reservoir for retaining a liquid. The cap member 12 includes a sleeve 16 to receive and conduit liquid contained within the reservoir of the hollow bodied container. A valve member 18 (FIG. 2) is retained within the sleeve 16 of the cap member 12. The valve member 18 is manufactured from a flexible polyurethane material. The valve member 18 includes a substantially flexible shaft 20 having a first end 22 projecting from said sleeve exterior 16.

A dispensing member 24 manufactured from a pad of felt co-operates with the first end 22 of the shaft and additionally surrounds the sleeve 16. The opposing end 26 of the valve member 18 is held in position by way of a retaining member 28 which is molded to a portion of the interior of the cap 12. The positioning of the retaining member 28 does not prevent fluid from passing from the reservoir to the sleeve 16 interior. The valve member 18 is flexibly operable against a bias at said first end to move from a first substantially closed position (FIG. 2) to a second open position (FIG. 3) to allow displacement of a quantity of liquid from within the sleeve 16, onto the dispensing member 24, for subsequent application.

PVC priming fluid is a ketone based solvent and is highly flammable. It is typically sold in 250 ml, 500 ml or 1 L screw top plastic containers and therefore can be held in the hand of a user. It is envisioned that the cap member will be manufactured from the same material which the containers which hold the PVC priming fluid are manufactured from. However it should be appreciated that the invention is not limited to the application of PVC priming fluid and is suitable for the application of any volatile fluid. Therefore the material from which the cap and valve member are manufactured from will change accordingly.

It is envisioned that the liquid dispensing applicator will be sold separately, or in conjunction with a container of PVC priming fluid. In use the cap of the container of PVC priming fluid is replaced with the cap member 12 of the liquid dispensing applicator 10. The container (not shown) to which the cap member is attached can be easily held by a user and manipulated to bring the dispensing member 24 into contact with a surface onto which the fluid is to be applied. The applicator 10 is tilted so that fluid enters the sleeve 16. Pressure is then applied against the dispensing member 24 such that the shaft 20 flexes against a bias to enable fluid to flow from within the shaft 16 and onto the dispensing member 24. By rolling the applicator 10 from side to side the fluid is able to be dispersed throughout the dispensing member 24, and in turn dispersed over the surface to which the fluid is to be applied.

It is envisioned that the dispensing applicator is for single use, however depending on the material from which the dispensing member 24 is manufactured from the liquid dispensing applicator 10 may be used several times.

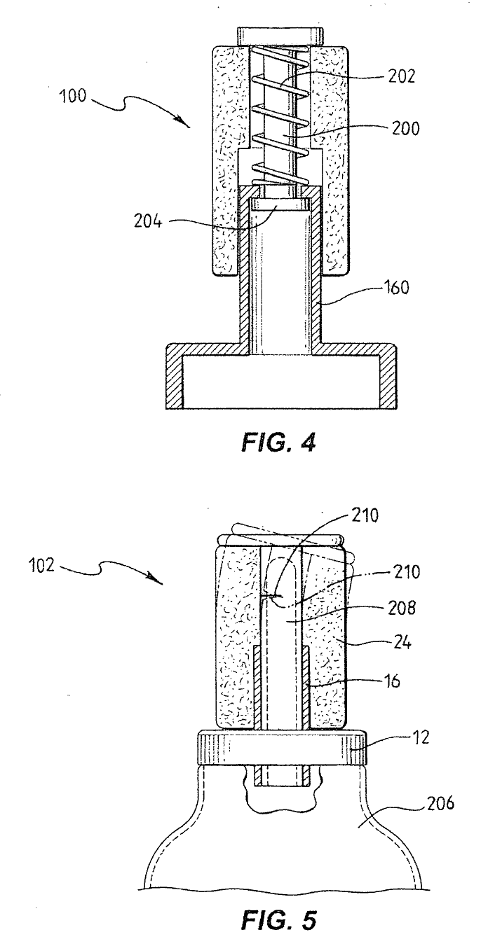

Referring now to FIG. 4, a liquid dispensing applicator 100 of a second embodiment is illustrated. In this embodiment, the valve member includes a spring 202 which is wound around the shaft 200. The end of the sleeve 160 which retains the valve member has an inwardly protruding rim 204. One end of the shaft 200 has an abutment means 204 to abut against the end of the sleeve 160.

The actuator is operable such that when an opposing end of the shaft 200 is depressed, the shaft 200 slides within the sleeve 160 to enable liquid to flow out of the

Referring now to FIG. 5, a liquid dispensing applicator 102 of a third embodiment is illustrated. Like numerals refer to like parts previously described unless otherwise specified. In this embodiment, the cap member 12 includes a sleeve 16 to receive and conduit liquid contained within the reservoir of the hollow bodied container 206. Shaft 208 having a first end projects from said sleeve exterior 16 and comprises a hollow core through which liquid can travel. The shaft is surrounded by a wall manufactured from an elastic material. A slit 210 is provided in a portion of the wall of the shaft 208 and extends through to the core. A dispensing member 24 surrounds the shaft 208. In use, the applicator 102 is tilted so that fluid passes through the core of the shaft 208. Pressure is then applied against the shaft 208 such that the shaft flexes, causing the slit 210 to open which enables liquid to flow from within the core of the shaft 208 and onto the dispensing member 24.

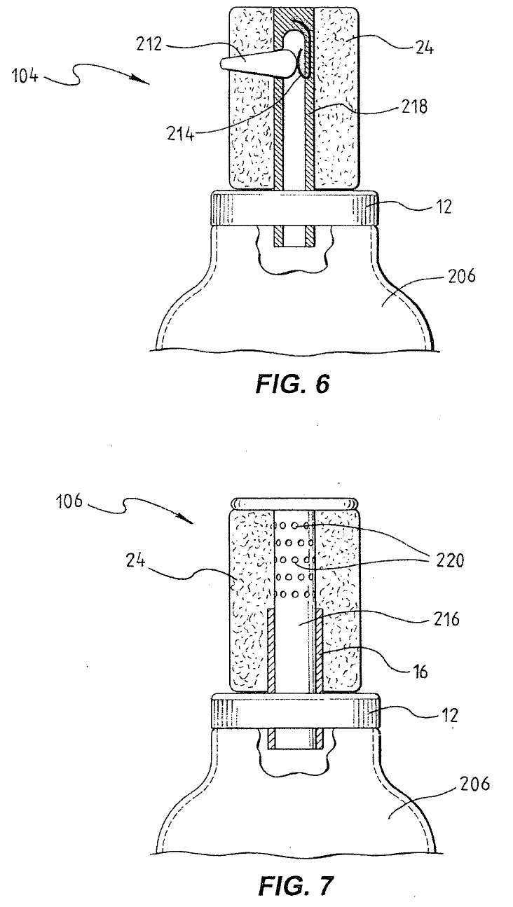

Referring now to FIG. 6, a liquid dispensing applicator 104 of a farther embodiment is illustrated. In this embodiment, the cap member 12 includes a shaft 218 having a hollow core to receive and conduit liquid. The shaft 218 is surrounded by a wall manufactured from a rigid material which has an aperture having a substantially fixed diameter. The valve member includes a wedge 212, a portion of which extends through the aperture and a spring 214 to bias the wedge 212 in a substantially sealable position within the aperture. Wien the tip of the wedge 212 is depressed, the spring 214 compresses to enable liquid to flow through the aperture and onto the dispensing member 24.

With reference to FIG. 7, a liquid dispensing applicator 106 of a still further embodiment is illustrated. In this embodiment, the cap member 12 includes a sleeve 16 to receive and conduit liquid contained within the reservoir of the hollow bodied container 206. A shaft 216 projects from said sleeve exterior, the shaft 216 having a plurality of openings 218 in the wall of the shaft. When sides of the container 206 are squeezed, liquid within the container 206 is forced to flow through the openings 218 and onto the dispensing member 24. With the exclusion of the openings 218, the interior wall of the shaft 216 is coated with a sealant to prevent leakage of liquid. The shaft may be substantially rigid and may be manufactured from an absorbent material. Additionally, the sleeve may be omitted.

Advantageously, the liquid dispensing applicator in accordance with any of the above embodiments can be easily fitted to a container of PVC priming fluid. The use of the liquid dispensing applicator in accordance with embodiments of the invention, reduces the likelihood of spillage and minimises contact against the user's skin. As a result, less fluid is required to be used relative to traditional techniques.

It should be appreciated that the invention is not limited to the application of priming fluids, and could be used to apply a wide range of liquids, regardless of their classification.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A liquid dispensing applicator for a volatile liquid, the liquid dispensing applicator comprising:
a cap member for attachment to a hollow bodied container having a reservoir for retaining a liquid, the cap member comprising a sleeve to receive and conduit liquid contained within the reservoir;
a valve member retained within the sleeve of the cap comprising a substantially flexible shaft having a first end projecting from said sleeve exterior; and
a dispensing member co-operating with at least the first end of the shaft;
wherein the valve member is flexibly operable against a bias to move from a first substantially closed position to a second open position to allow displacement of a quantity of liquid from within the sleeve, onto the dispensing member, for subsequent application.

2. A liquid dispensing applicator according to claim 1, where the valve member further comprises a retaining member to retain a second end of the substantially flexible shaft in position relative to the sleeve.

3. A liquid dispensing applicator according to claim 1, where the shaft is hollow to receive and conduit liquid contained within the sleeve and a slit is provided in a portion of a wall of the first end of the shaft.

4. A liquid dispensing applicator according claim 1, where the valve member comprises a spring wound around the shaft.

5. A liquid dispensing applicator according to claim 1, where the cap member is removably attachable to a container.

6. A liquid dispensing applicator according to claim 5, where the cap member includes an internal thread to attach to a neck of the container.

7. A liquid dispensing applicator claim 1, where the valve member is manufactured from one of a rubber and a flexible polyurethane material.

8. A liquid dispensing applicator according to claim 1, further comprising a lock mechanism to prevent unintentional displacement of the valve member from the first closed position to the second open position.

9. A liquid dispensing applicator according to claim 1, further comprising a substantially rigid cap to removably surround the dispensing member.

10. A liquid dispensing applicator according to claim 1, where the dispensing member is manufactured from an absorbent material.

11. A liquid dispensing applicator according to claim 10, where the absorbent member is a felt pad.

12. A liquid dispensing applicator according to claim 10, where the absorbent member comprises a composite material.

13. A liquid dispensing applicator according to claim 1, where the dispensing member substantially surrounds the portion of the shaft projecting from said sleeve exterior and at least a portion of an exterior of the sleeve.

14. A liquid dispensing applicator according to claim 1, where exterior surfaces of the portion of the shaft projecting from said sleeve exterior and the sleeve exterior include a plurality of barbs and the dispensing member is fixedly attached to the barbs.

15. A method of applying a volatile liquid from a container to a surface; the method comprising:
incorporating an applicator into a container, the applicator comprising:
a cap member for attachment to a hollow bodied container having a reservoir for retaining a liquid, the cap member comprising a sleeve to receive and conduit liquid contained within the reservoir;
a valve member retained within the sleeve of the cap comprising a substantially flexible shaft having a first end projecting from said sleeve exterior; and
a dispensing member co-operating with at least the first end of the shaft;
wherein the valve member is flexibly operable against a bias to move from a first substantially closed position to a second open position to allow displacement of a quantity of liquid from within the sleeve, onto the dispensing member, for subsequent application; and
urging the applicator into contact with a surface, thereby to cause liquid in the container to flow from the applicator onto the surface; wherein the method is applied preparatory to a pipe joining operation.

16. The method according to claim 15, further comprising tilting the container and applicator so as to cause the fluid to flow into a sleeve member of the applicator.

17. The method according to claim 15, wherein pressure applied to the applicator against the surface causes a flexing of the valve member of the applicator; the flexing allowing fluid to flow into the sleeve member.

18. The method according to claim 15, wherein the surface is a portion of a polyvinyl chloride pipe join or other thermoplastics pipe join.
